(19) United States
(12) Patent Application Publication
(10) Pub. No.: US 2010/0238506 A1
(43) Pub. Date: Sep. 23, 2010

(54) DOCUMENT PROCESSING SYSTEM, SEARCH APPARATUS, INFORMATION SEARCHING METHOD, DOCUMENT PROCESSING METHOD AND COMPUTER READABLE MEDIUM

(75) Inventor: Tetsunori MURAKAMI, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Minato-ku (JP)

(21) Appl. No.: 12/540,166

(22) Filed: Aug. 12, 2009

(30) Foreign Application Priority Data
Mar. 18, 2009 (JP) 2009-065468

(51) Int. Cl. G06K 15/00; H04N 1/04

(52) U.S. Cl. 358/1.16; 358/474

(57) ABSTRACT

The document processing system is provided with: a printing unit that prints a document image on a medium; an image reading unit that performs image reading on the medium; a holding unit that holds history information on processing performed by the printing unit; and a search unit that searches the history information held by the holding unit on the basis of an image of a printout which is the medium with the document image printed on the medium by the printing unit. The search unit determines similarity between the image of the printout and a synthetic image in which the document image is synthesized with an image of the medium read by the image reading unit, and searches for history information on processing performed for the printout on the basis of a result of the determination.

### CROSS REFERENCE TO RELATED APPLICATIONS

This application is based on and claims priority under 35 USC §119 from Japanese Patent Application No. 2009-65468 filed Mar. 18, 2009.

### BACKGROUND

1. Technical Field

The present invention relates to a document processing system, a search apparatus, an information searching method, a document processing method and a computer readable medium storing a program.

2. Related Art

In image processors such as a printer, a scanner, a facsimile and a multifunction machine that includes those functions in one, log information (history information) of image processing is stored in a memory in some cases. In such a case, not only information on a type of processing, a time when the processing is performed, and the like, but also an image itself on which the processing is performed is stored in some cases. In such a case, in general, electronic images produced (rasterized) in each of the image processors are accumulated.

If such log information is stored, an image identical or similar to a printed-out image is searchable in the log information by using the printed-out image as a key. In this image search, it is necessary to determine similarity between images.

### SUMMARY

According to an aspect of the present invention, there is provided a document processing system including: a printing unit that prints a document image on a medium; an image reading unit that performs image reading on the medium; a holding unit that holds history information on processing performed by the printing unit; and a search unit that searches the history information held by the holding unit on the basis of an image of a printout which is the medium with the document image printed on the medium by the printing unit. The search unit determines similarity between the image of the printout and a synthetic image in which the document image is synthesized with an image of the medium read by the image reading unit, and searches for history information on processing performed for the printout on the basis of a result of the determination.

### BRIEF DESCRIPTION OF THE DRAWINGS

Exemplary embodiment(s) of the present invention will be described in detail based on the following figures, wherein:

FIG. 1 is a diagram showing an entire configuration of a document processing system of the exemplary embodiment;

FIGS. 2A and 2B are views each showing an electronic document and a paper sheet (a medium), and a relationship among images thereof and a printout image;

FIG. 3 is a diagram showing an example of a functional configuration of the document processing system in the exemplary embodiment.

FIG. 4 is a flowchart showing a content of, and a procedure of search processing performed by the search apparatus of the system shown in FIG. 3;

FIG. 5 is a diagram showing another example of the functional configuration of the document processing system in the exemplary embodiment;

FIG. 6 is a flowchart showing a content of, and a procedure of search processing performed by the search apparatus of the system shown in FIG. 5;

FIG. 7 is a diagram showing an example of the functional configuration of the document processing system in a case where the medium image is produced on the basis of the code information;

FIG. 8 is a diagram showing still another example of the functional configuration of the document processing system in the exemplary embodiment; and

FIG. 9 shows an example of a hardware configuration of a computer that implements the search apparatus in the exemplary embodiment.

### DETAILED DESCRIPTION

An exemplary embodiment of the present invention will be described below in detail with reference to the accompanying drawings.

### <System Configuration>

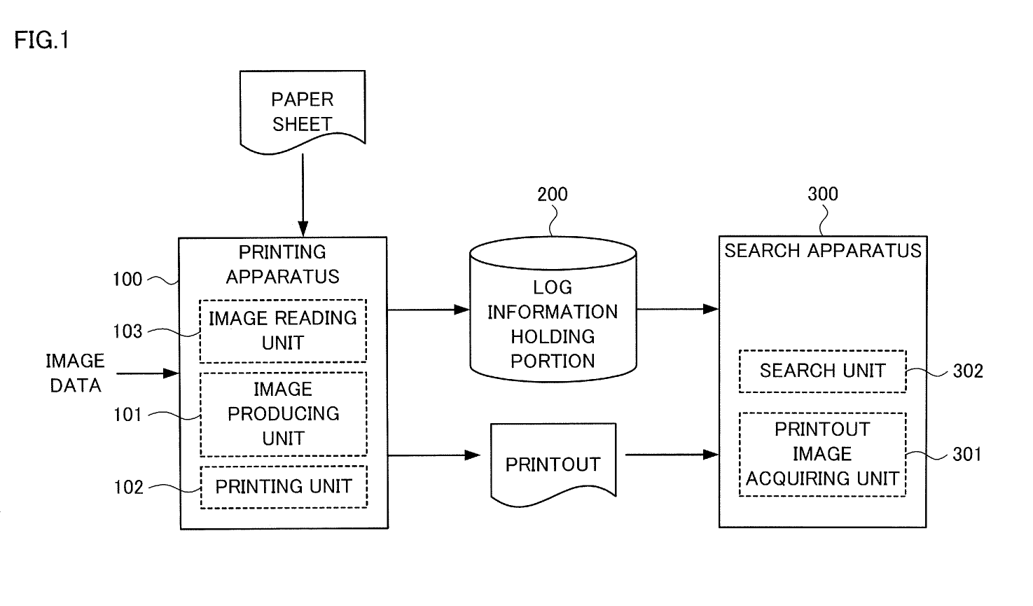

FIG. 1 is a diagram showing an entire configuration of a document processing system of the exemplary embodiment.

The system of the present exemplary embodiment includes a printing apparatus 100, a log information holding portion 200 and a search apparatus 300 as shown in FIG. 1.

The printing apparatus 100 produces a document image to be printed, and prints and outputs the document image on a medium such as a paper sheet. This printing apparatus 100 is implemented as a printer or a copy machine. Here, a document image represents an electronic image of a document to be printed on a medium. Additionally, although the word “document” is used, a content of a document image is not limited to text, and thus a document image includes only a picture or an image generated by computer graphics.

As shown in FIG. 1, the printing apparatus 100 of the present exemplary embodiment includes: an image producing unit 101 that, on the basis of image data, produces (rasterizes) a document image to be printed; and a printing unit 102 that prints the produced image on a medium (a paper sheet). Additionally, the printing apparatus 100 includes an image reading unit 103 used for acquiring an image of the medium. Here, the image data includes data described in a page description language (PDL) or the like, and scanned image data read by a scanner, which are produced by using a personal computer or the like. If the printing apparatus 100 is a copy machine, the image data is usually scanned image data read by a scanner function of the copy machine.

The image producing unit 101 acquires the above-mentioned image data by receiving the image data from an external apparatus such as a personal computer or by reading the image data by use of a scanner function of the printing apparatus 100. Then, the image producing unit 101 expands the thus acquired image data into a memory, thereby producing the document image that is a raster image.

The printing unit 102 prints the document image, which is produced by the image producing unit 101, on the medium by using an image forming material such as toner or ink. In the present exemplary embodiment, a printing method is not limited. That is, the present exemplary embodiment is applicable to the printing unit 102 for which any one of various methods such as an electrophotographic method, an inkjet method and a thermal method is employed.

The image reading unit 103 reads an image of the medium (hereinafter, a medium image) by use of the scanner function. In some cases, other than white paper having nothing shown thereon as a background, a paper sheet having a color or a pattern applied thereto, a paper sheet having a letter or a figure already printed thereon, or the like may be used as a medium for printing. For this reason, a medium image is read so as to acquire information indicating characteristics of such a medium itself as an image. Although detailed description will be given later, the present exemplary embodiment includes, depending on implementation forms, a case where an image is read after a document image produced by the image producing unit 101 is printed on a medium by the printing unit 102 (that is, an image of a printout), and a case where an image is read only from a medium before a document image is printed thereon.

The log information holding portion 200 is a holding unit that acquires and holds log information (history information) on image processing performed by the printing apparatus 100. This log information holding portion 200 is formed of a readable and writable memory such as a magnetic disk device. In the present exemplary embodiment, an image log, which includes an image subjected to the processing, is acquired as the log information. This image log includes a part called a job log and a part called a log image.

Attribute information on content of the processing is recorded in the jog log. The attribute information includes information such as a subject that performs the processing, a time when the processing is performed, and the content of the processing. For example, in a case where copying is performed as the processing (a job), recorded therein is such information as identification information of an apparatus, identification information of an executor of the processing, a date and time when the processing is executed, and a flag indicating that the executed processing is copying. The log image is an image subjected to the processing (the job). Although detailed description will be given later, the present exemplary embodiment includes: a case where this log image is broken down into a document image produced by the image producing unit 101 of the printing apparatus 100 and a medium image read by the image reading unit 103 of the printing apparatus 100; and a case where this log image is a single image obtained by synthesizing those images.

By using an image printed on a medium by the printing unit 102 of the printing apparatus 100 as a search key, the search apparatus 300 searches image logs held in the log information holding portion 200. That is, the search apparatus 300 of the present exemplary embodiment performs image search. This search apparatus 300 is implemented by an information processing apparatus such as a personal computer. In the present exemplary embodiment, a method for image search is not particularly limited, and an existing method such as one disclosed in Patent Document 1 (Japanese Patent Application Laid Open Publication No. 2003-256427) may be employed.

As shown in FIG. 1, the search apparatus 300 of the present exemplary embodiment includes a printout image acquiring unit 301 and a search unit 302. The printout image acquiring unit 301 acquires an image of a printout (a printout image) read by a scanner. By using the printout image obtained by the printout image acquiring unit 301 as a search key, the search unit 302 searches image logs held in the log information holding portion 200.

Note that, although the printing apparatus 100, the log information holding portion 200 and the search apparatus 300 are separately shown in FIG. 1, these elements are not necessarily formed of separate pieces of hardware in an actual system. For example, the log information holding portion 200 may be formed as a log management apparatus by being mounted as a memory device, such as a magnetic disk device, provided in the search apparatus 300. Alternatively, the log information holding portion 200 may be mounted as a memory device provided in the printing apparatus 100. Otherwise, all of functions of the printing apparatus 100, the log information holding portion 200 and the search apparatus 300 may be configured as functions of a single piece of hardware.

### <Image Subjected to Search>

An image subjected to search in the present exemplary embodiment will be described.

For searching image logs, similarity between a printout image and each of log images included in the image logs is necessary to be determined in some cases. Here, in a case where a document image is printed on a paper sheet such as a paper sheet having a color or a pattern applied thereto, or a paper sheet having a letter or a figure already printed thereon, the printed image shows that the document image is superimposed on the color, the pattern, the letter, the figure, or the like already applied to the paper sheet. For this reason, similarity between the printout image and each of the log images may be inaccurately determined in the image search.

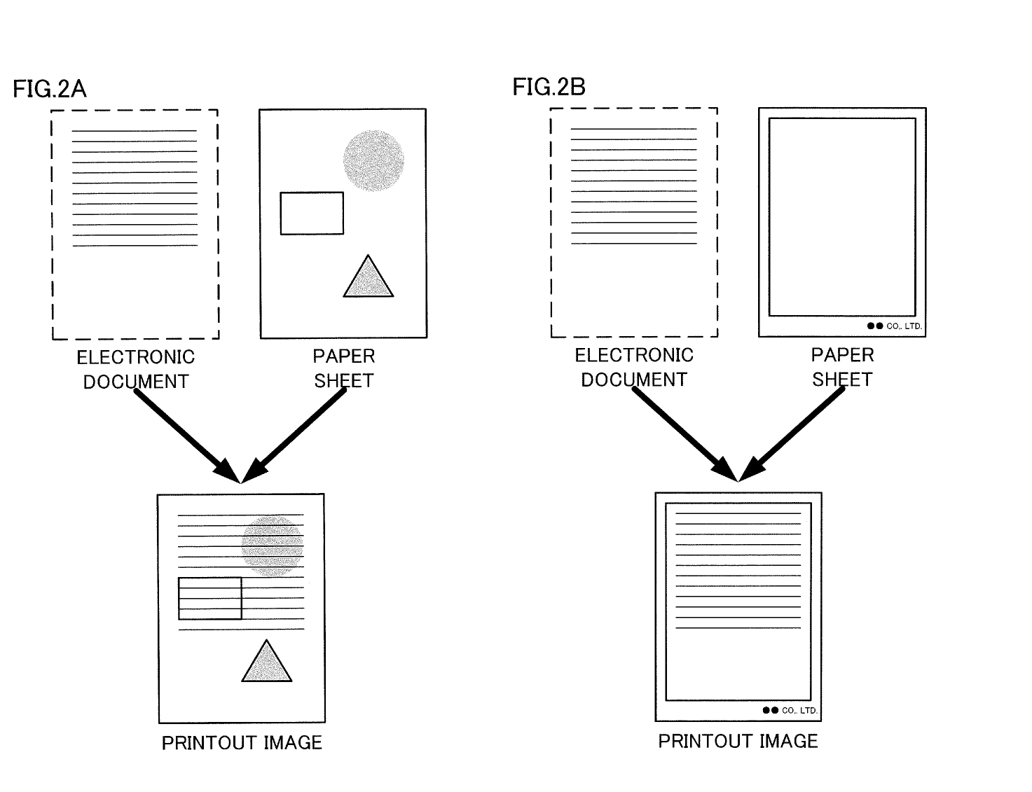

FIGS. 2A and 2B are views each showing an electronic document and a paper sheet (a medium), and a relationship among images thereof and a printout image.

FIGS. 2A and 2B show manners in which printout images are obtained by printing, on different paper sheets, a document image produced from the same electronic document. As illustrated, by printing the document image on the paper sheets, the document image and medium images of the paper sheets are superimposed to form the printout images. Here, between FIGS. 2A and 2B, designs of the paper sheets before the document image is printed are different. For this reason, even though the document image is the same, the printout images in each of which the document image and a corresponding one of the medium images are superimposed on each other are different from each other.

In a case where only the document image produced by the image producing unit 101 of the printing apparatus 100 is stored as a log image in each image log, neither of the printout images in FIGS. 2A and 2B is similar to the document image. For this reason, even if the log images are searched by using the printout image as a search key (a key image), accurate detection of the document image formed on printouts is difficult.

Therefore, in the present exemplary embodiment, the document image and a medium image (including an image obtained by synthesizing these images) are stored as the log image as has been described above with reference to FIG. 1. This log image corresponds to a printout image in which a document image and a medium image are superimposed on each other. Thereby, accurate search of the image logs by using the printout image as a search key is implemented.

Additionally, in the present exemplary embodiment, each of the following methods is proposed in order to obtain the above-mentioned printout image in which the document image and the medium image are superimposed on each other:

a method (1) in which the medium image is acquired by performing image reading (scanning) on a paper sheet, this medium image and the document image are synthesized, and a thus obtained synthetic image is stored as a log image;

a method (2) in which the medium image is acquired by performing image reading on a paper sheet, this medium image and the document image are stored as a log image, and then, when image logs are searched, the document image and the medium image are synthesized to be compared with the printout image; and

a method (3) in which the image in which the document image and the medium image are superimposed is acquired by performing image reading on the paper sheet after the document image is printed thereon, and the printout image is stored as a log image.

Specific functional configurations of the printing apparatus 100 and the search apparatus 300 in the system shown in FIG. 1 differ by which one of the above-mentioned methods is employed as a method for acquiring the printout image. Therefore, specific functional configurations of the system which correspond to the respective methods will be separately described below.

### <Functional Configuration of System Corresponding to Method (1)>

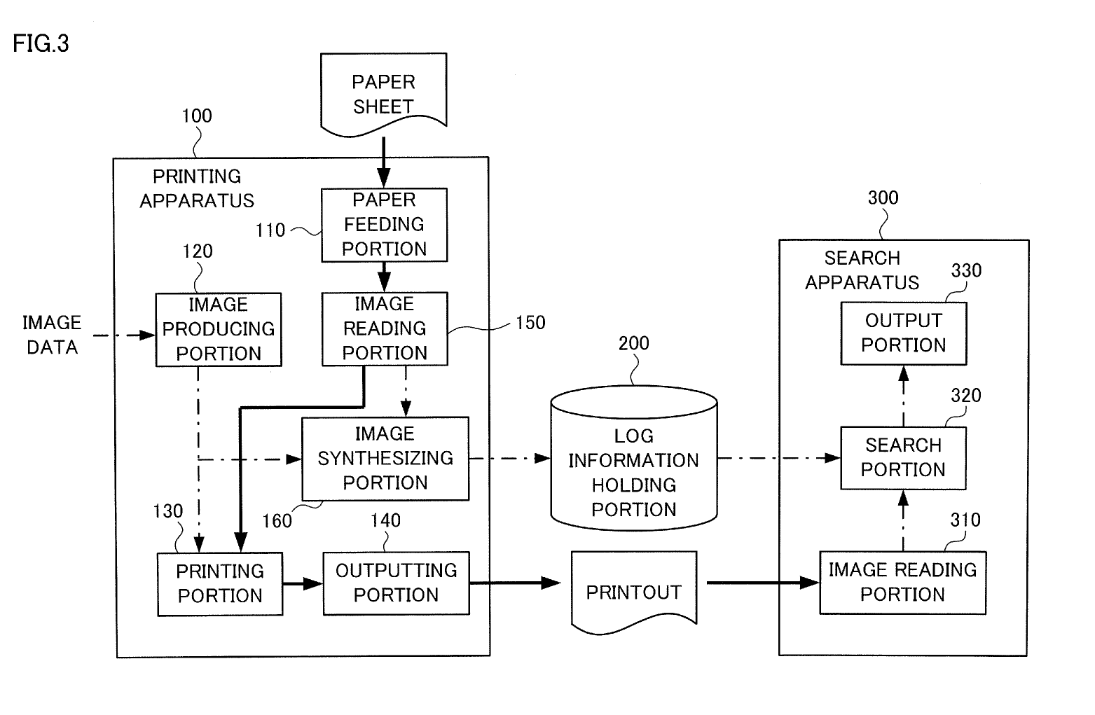

FIG. 3 is a diagram showing an example of a functional configuration of the document processing system in the exemplary embodiment.

The system shown in FIG. 3 corresponds to the above-mentioned method (1). That is, a paper sheet is subjected to image reading before a document image is printed thereon, whereby a medium image is acquired. Additionally, a synthetic image obtained by synthesizing this medium image and the document image is stored as a log image. Note that, in FIG. 3, a solid line indicates a route along which a paper sheet as a medium is transported, whereas a dashed-dotted line indicates a route along which image data is transmitted.

In the system shown in FIG. 3, the printing apparatus 100 includes a paper feeing portion 110, an image producing portion 120, a printing portion 130, an outputting portion 140, an image reading portion 150 and an image synthesizing portion 160. Among these elements, the image producing portion 120, the printing portion 130 and the image reading portion 150 correspond to the image producing unit 101 shown in FIG. 1, the printing unit 102 shown in FIG. 1 and the image reading unit 103 shown in FIG. 1, respectively.

The paper feeing portion 110 is configured by including a cassette that contains paper sheets (media), a transporting mechanism that transports the paper sheets, and the like, and thereby feeds the paper sheets to the image reading portion 150.

The image producing portion 120 is implemented by a controller (a computer) of the printing apparatus 100, and thereby, acquires image data to be printed, and produces a document image (a raster image). The produced document image is transmitted to the printing portion 130 and the image synthesizing portion 160.

The printing portion 130 includes a printing mechanism based on an electrophotographic method or an inkjet method, and thereby prints a document image on a paper sheet fed thereto via the image reading portion 150. Here, the document image is received from the image producing portion 120. The paper sheet (a printout) having the document image printed thereon is transported to the outputting portion 140.

The outputting portion 140 is configured by including a transporting mechanism that transports paper sheets, a tray that receives outputted paper sheets, and the like, and thereby outputs, to the outside of the printing apparatus 100, paper sheets having document images printed thereon.

The image reading portion 150 is implemented by the scanner function and the controller which are provided in the printing unit 100, and thereby, performs image reading on a paper sheet fed from the paper feeding portion 110 so as to acquire a medium image (an electronic image). Then, the image reading portion 150 transmits the acquired medium image to the image synthesizing portion 160. The paper sheet after the reading is completed is transported to the printing portion 130.

The image synthesizing portion 160 is implemented by the controller of the printing unit 100, and thereby, synthesizes the document image produced by the image producing portion 120 and the medium image acquired by the image reading portion 150 so as to produce a synthetic image. This synthetic image corresponds to a printout image obtained by performing image reading on the above-mentioned printout.

The controller (not shown in the figure) of the printing apparatus 100 produces an image log by setting this synthetic image as a log image, and adding a job log thereto, and thereby causes the log information holding portion 200 to hold the image log.

In the system shown in FIG. 3, the search apparatus 300 includes an image reading portion 310, a search portion 320 and an output portion 330. Among these elements, the image reading portion 310 and the search portion 320 correspond to the printout image acquiring unit 301 shown in FIG. 1 and the search unit 302 shown in FIG. 1, respectively.

The image reading portion 310 is implemented by a scanner and a program-controlled CPU, and thereby performs image reading on a printout so as to acquire a printout image (an electronic image). Then, the image reading portion 310 transmits the acquired printout image to the search portion 320.

The search portion 320 searches image logs held by the log information holding portion 200 by using the printout image read by the image reading portion 310 as a search key. In the present exemplary embodiment, the image logs are rearranged in descending order of degrees of similarity of the log images with respect to the printout image, and the rearranged image logs are provided as a search result. In a case where the number of the image logs is large, a certain number of image logs higher in degree of similarity may be extracted and provided as the search result.

The output portion 330 displays, on a display device (not shown in the figure), information (information contained in job logs, and images in the log images) on the image logs obtained as the search result of the search portion 320. At this time, the output portion 330 accepts an operation from a user, and sequentially outputs and displays the information on the image logs in descending order of degrees of similarity, which are determined in the search performed by the search portion 320.

Any one of various existing determination methods is applicable to determination made by the search portion 320 of a degree of similarity between images. However, since criteria for similarity determination that are appropriate for detecting a desired image log may possibly differ case by case, an appropriate image log may not be always detected through similarity determination automatically made by the search portion 320. Therefore, in the present exemplary embodiment, the search portion 320 rearranges the image logs in descending order of degrees of similarity of the log images with respect to the printout image, and human visual judgment is allowed by having the rearranged image logs displayed by the output portion 330. That is, a user is allowed to visually check the image logs displayed by the output portion 330, and specify an image log desired by the user.

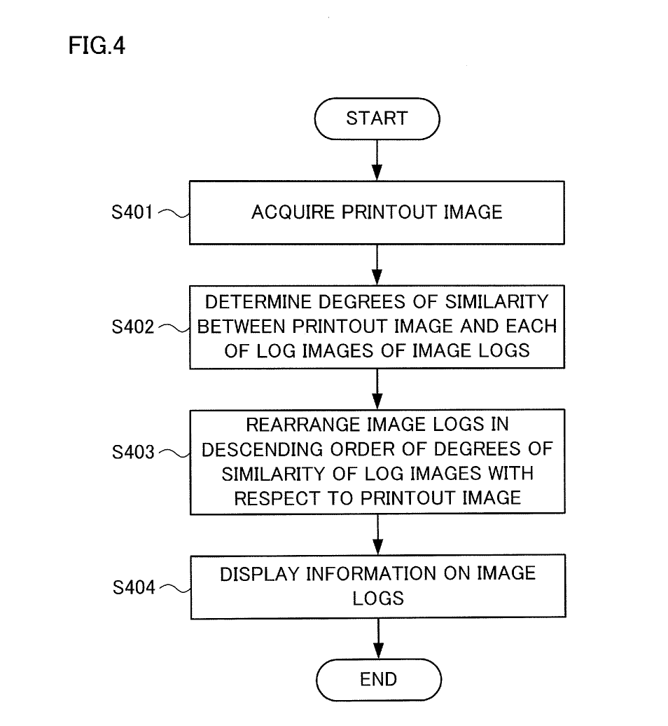

FIG. 4 is a flowchart showing a content of, and a procedure of search processing performed by the search apparatus 300 of the system shown in FIG. 3.

With reference to FIG. 4, first of all, the image reading portion 310 performs image reading on a printout, thereby acquiring a printout image (step 401). Then, the search portion 320 reads image logs out from the log information holding portion 200, and determines degrees of similarity between the printout image acquired in step 401 and each of log images of the image logs (step 402). Then, on the basis of a determination result in step 402, the search portion 320 rearranges the image logs in descending order of the degrees of similarity of the log images with respect to the printout image (step 403). Thereafter, the output portion 330 displays information on the image logs in accordance with the order in which the image logs are rearranged in step 403 (step 404).

### <Functional Configuration of System Corresponding to Method (2)>

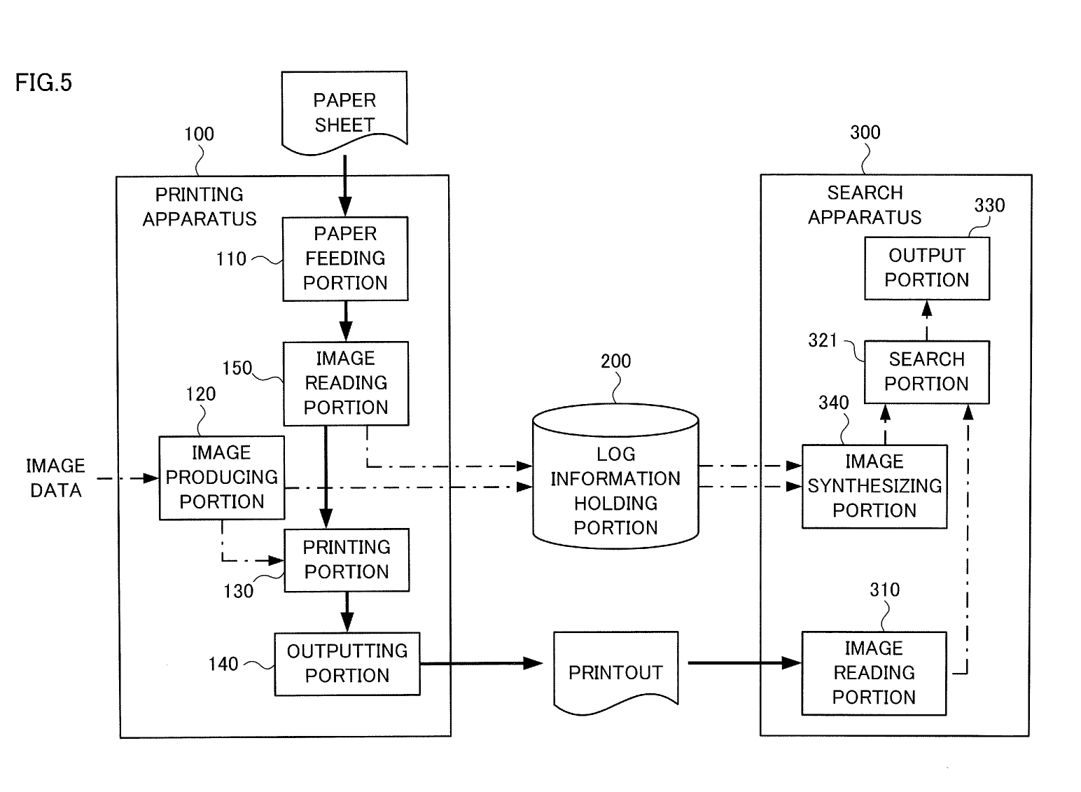

FIG. 5 is a diagram showing another example of the functional configuration of the document processing system in the exemplary embodiment.

The system shown in FIG. 5 corresponds to the above-mentioned method (2). That is, a paper sheet is subjected to image reading before the document image is printed thereon, whereby a medium image is acquired. Additionally, the document image and the medium image are each stored as a log image. Note that, in FIG. 5 as well as in FIG. 3, a solid line indicates a route along which a paper sheet as a medium is transported, whereas a dashed-dotted line indicates a route along which image data is transmitted.

In the system shown in FIG. 5, the printing apparatus 100 includes the paper feeing portion 110, the image producing portion 120, the printing portion 130, the outputting portion 140 and the image reading portion 150. Among these elements, the image producing portion 120, the printing portion 130 and the image reading portion 150 correspond to the image producing unit 101 shown in FIG. 1, the printing unit 102 shown in FIG. 1 and the image reading unit 103 shown in FIG. 1, respectively. Additionally, functions of the paper feeing portion 110, the image producing portion 120, the printing portion 130 and the outputting portion 140 are the same as the corresponding functions of the printing unit 100 in the system shown in FIG. 3.

The image reading portion 150 is implemented by the scanner function and the controller which are provided in the printing unit 100, and thereby, performs image reading on a paper sheet so as to acquire a medium image (an electronic image). Here, the paper sheet is fed from the paper feeding portion 110. The paper sheet after the reading is completed is transported to the printing portion 130.

The controller (not shown in the figure) of the printing apparatus 100 produces an image log by setting, as a log image, the document image produced by the image producing portion 120 and the medium image acquired by the image reading portion 150, and by adding a job log thereto, and thereby causes the log information holding portion 200 to hold the image log.

In the system shown in FIG. 5, the search apparatus 300 includes the image reading portion 310, a search portion 321, the output portion 330 and an image synthesizing portion 340. Among these elements, the image reading portion 310 and the search portion 321 correspond to the printout image acquiring unit 301 shown in FIG. 1 and the search unit 302 shown in FIG. 1, respectively. Additionally, functions of the image reading portion 310 and the output portion 330 are the same as the corresponding functions of the search apparatus 300 in the system shown in FIG. 3.

The image synthesizing portion 340 acquires image logs from the log information holding portion 200, and synthesizes a document image and a medium image to produce a synthetic image. Here, the document image and the medium image are contained as a log image in each of the image logs. Each synthetic image corresponds to a printout image obtained by causing the image reading portion 310 to perform image reading on a printout.

By using the printout image acquired by the image reading portion 310 as a search key, the search portion 321 searches the image logs held by the log information holding portion 200. In the present exemplary embodiment, degrees of similarity between the printout image and each of the log images are determined by use of the synthetic images produced by the image synthesizing portion 340, and document images contained in the log images of the image logs.

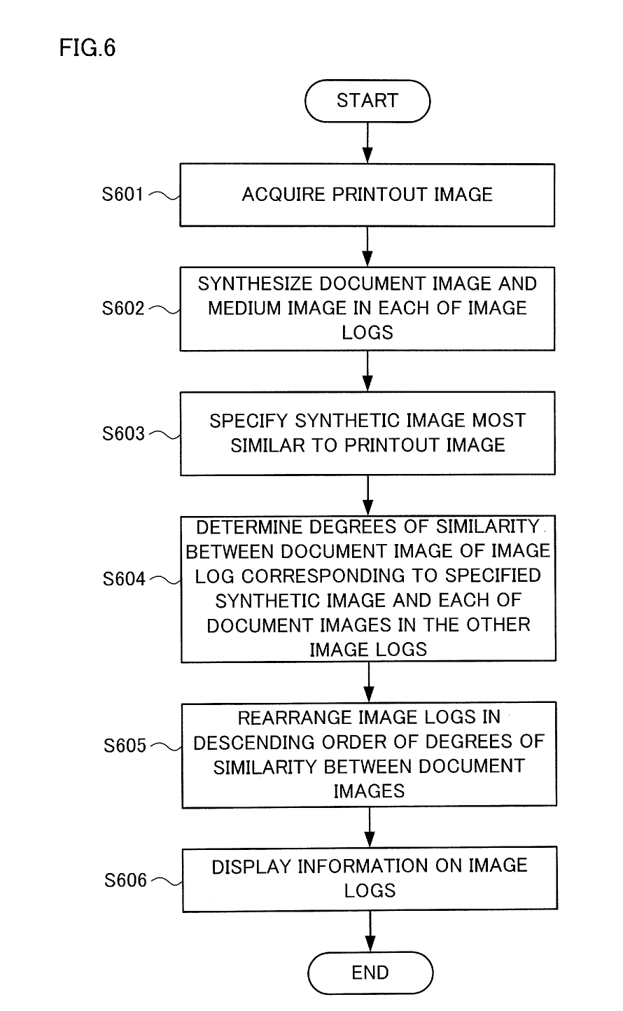

FIG. 6 is a flowchart showing a content of, and a procedure of search processing performed by the search apparatus 300 of the system shown in FIG. 5.

With reference to FIG. 6, first of all, the image reading portion 310 performs image reading on a printout, and thereby acquires a printout image (step 601). Additionally, the image synthesizing portion 340 reads image logs out from the log information holding portion 200, and synthesizes a document image and a medium image which are contained in a log image of each of the image logs (step 602). Then, the search portion 321 determines degrees of similarity between the printout image and each of the synthetic images thus produced in step 602, and specifies one of the synthetic images, which is the most similar to the printout image (step 603).

Subsequently, the search portion 321 extracts a document image of an image log corresponding to the synthetic image specified in step 603. Then, by using this document image as a key image, the search portion 321 determines degrees of similarity between the document image and each of the document images contained in the log images of the other image logs (step 604). Here, the degrees of similarity between the document images are determined, whereby image logs relating to processing performed on document images having the same content are detected without being influenced by medium images.

Thereafter, the search portion 321 rearranges the image logs in descending order of the degrees of similarity between the document images on the basis of a result of the determination in step 604 (step 605). Then, the output portion 330 displays information on the image logs in accordance with the order in which the image logs are rearranged in step 605 (step 606).

In the above configuration, each of the image logs contains a document image and a medium image, as a log image. Consequently, the document images and the synthetic images may be redundantly used as images subjected to similarity degree determination with the printout image. In the operation example shown in FIG. 6, each of the synthetic images and the printout image are compared to each other, one of the synthetic images, which is the most similar to the printout image, is specified, and then degrees of similarity are determined between document images. However, in addition to the above, a step of determining a degree of similarity by directly comparing the printout image and each of the document images with each other may be provided. An accuracy of a determination result on the degrees of similarity may be enhanced by comparing, with each other, a determination result on degrees of similarity between each of the synthetic images and the document image; and a determination result on degrees of similarity between each of the document images and the printout image. Additionally, in a case where a paper sheet having the document image printed thereon is formed of white paper having nothing as background, degrees of similarity with the printout image may be determined for the document images without any synthetic images produced by the image synthesizing portion 340. Furthermore, although degrees of similarity are determined between document images in step 604 mentioned above, degrees of similarity may be intentionally determined between synthetic images under the assumption that medium images influence the determination.

Additionally, although, in the above configuration, the description has been given for each of the log images containing both of a document image and a medium image, only a document image may be included in the log image held by the image log, whereas a medium image may be held by the image log, as a file different from the image log. In this case, it is necessary that an image log and a file of a medium image of a paper sheet used in document processing (printing) specified by this image log should be associated with each other by a unit such as a table or a pointer. With reference to this table or pointer, the image synthesizing portion 340 of the search unit 300 acquires an image log and a medium image associated with the image log, and thereby produces a synthetic image.

Incidentally, in the above configuration and the operation example, a medium image is acquired by performing image reading on a paper sheet, and a synthetic image is produced by synthesizing this medium image and a document image. However, information indicating characteristics (a color, a pattern, a kind and a position of any printed letter or figure, and the like) of a paper sheet as an image may be converted into a code and recorded on the paper sheet, and be read when image reading is performed. In this case, it is only necessary to store the information (hereinafter, referred to as code information) read from the code in an image log, and it is unnecessary to store therein a medium image in the form of an electronic image. When the search apparatus 300 produces a synthetic image, it is only necessary that the search apparatus 300 should produce a medium image of the paper sheet on the basis of this code information, and synthesize a document image and the medium image.

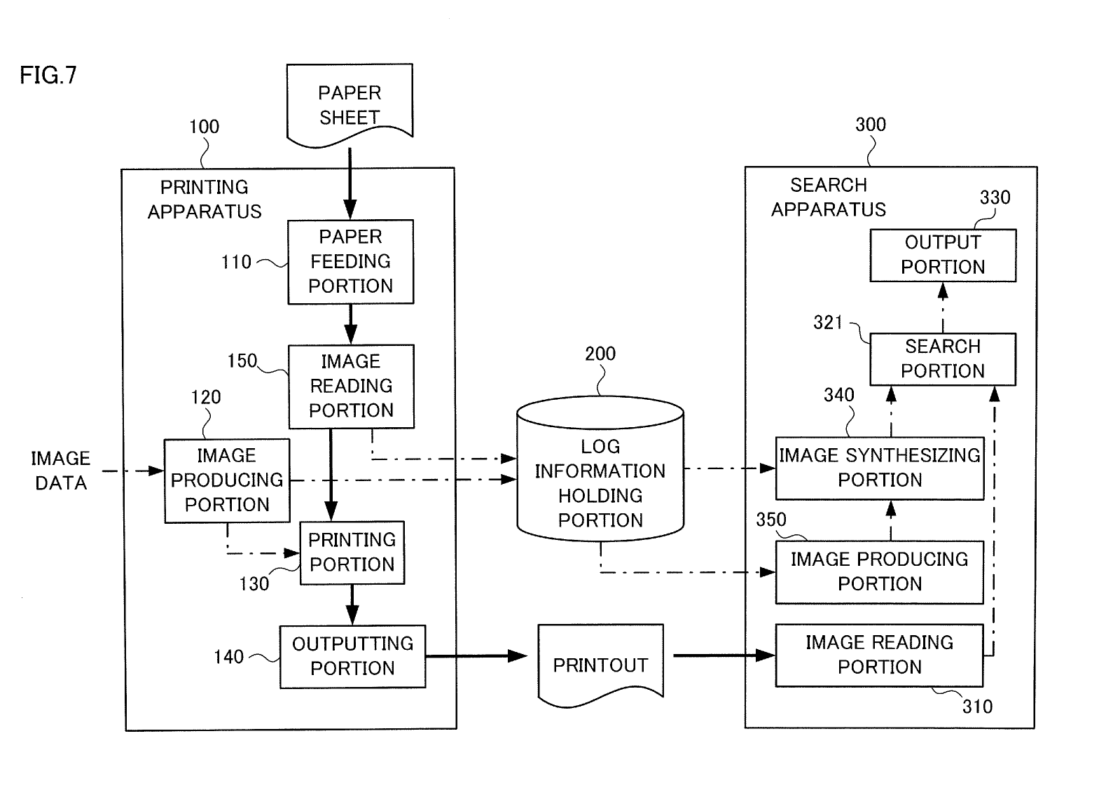

FIG. 7 is a diagram showing an example of the functional configuration of the document processing system in a case where the medium image is produced on the basis of the code information.

In this configuration, as has been described above, not the medium image itself but the code information read by the image reading portion 150 of the printing apparatus 100 is written into a job log of an image log, and is held by the log information holding portion 200. Otherwise, the code information may be configured not to be contained in the job log of the image log, but to be stored as a different file in association with the image log.

As shown in FIG. 7, the search apparatus 300 includes an image producing portion 350. The image producing portion 350 acquires pieces of code information from the log information holding portion 200, and produces medium images on the basis of these pieces of code information. The thus produced medium images are transmitted to the image synthesizing portion 340. The image synthesizing portion 340 synthesizes each of the medium images acquired from the image producing portion 350 and a corresponding one of document images acquired from the log information holding portion 200, and transmits thus obtained synthetic images to the search portion 321. A content of processing performed by the search portion 321 is the same as one shown in FIG. 6.

### <Functional Configuration of System Corresponding to Method (3)>

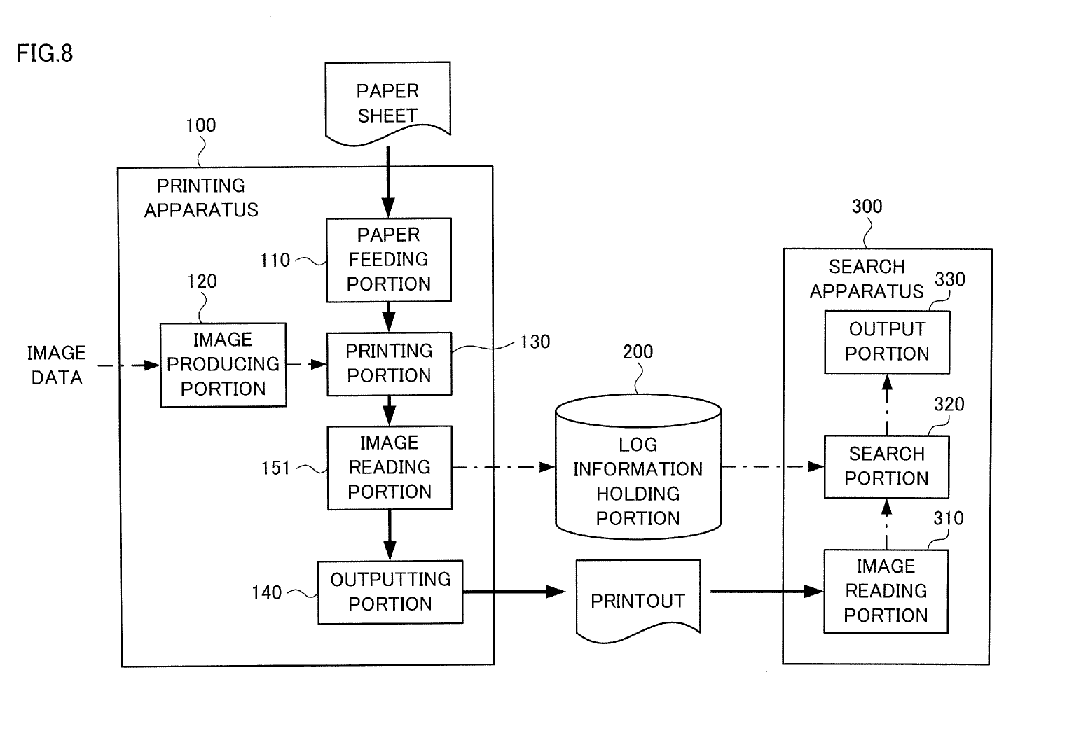

FIG. 8 is a diagram showing still another example of the functional configuration of the document processing system in the exemplary embodiment.

The system shown in FIG. 8 corresponds to the above-mentioned method (3). That is, a paper sheet is subjected to image reading after the document image is printed thereon, whereby an image is acquired. Then, this image is stored as a log image. Note that, in FIG. 8 as well as in FIG. 3, a solid line indicates a route along which a paper sheet as a medium is transported, whereas a dashed-dotted line indicates a route along which image data is transmitted.

In the system shown in FIG. 8, the printing apparatus 100 includes the paper feeing portion 110, the image producing portion 120, the printing portion 130, the outputting portion 140 and an image reading portion 151. Among these elements, the image producing portion 120, the printing portion 130 and the image reading portion 151 correspond to the image producing unit 101 shown in FIG. 1, the printing unit 102 shown in FIG. 1 and the image reading unit 103 shown in FIG. 1, respectively. Additionally, functions of the paper feeing portion 110, the image producing portion 120, the printing portion 130 and the outputting portion 140 are the same as the corresponding functions of the printing unit 100 in the system shown in FIG. 3.

In the system shown in FIG. 8, a paper sheet is transported from the paper feeing portion 110 directly to the printing portion 130. Then, a document image produced by the image producing portion 120 is printed on the paper sheet. The paper sheet having the document image printed thereon is transported to the image reading portion 151.

The image reading portion 151 performs image reading on the paper sheet after the document image is printed by the printing portion 130. The image acquired by this image reading is a printout image itself. The paper sheet after the reading is completed is transported to the outputting portion 140.

The controller (not shown in the figure) of the printing apparatus 100 produces an image log by setting, as a log image, the image acquired by the image reading portion 151, and by adding a job log thereto, and thereby causes the log information holding portion 200 to hold the image log.

In the system shown in FIG. 8, the search apparatus 300 includes the image reading portion 310, the search portion 320 and the output portion 330. Among these elements, the image reading portion 310 and the search portion 320 correspond to the printout image acquiring unit 301 shown in FIG. 1 and the search unit 302 shown in FIG. 1, respectively. Additionally, functions of the image reading portion 310, the search portion 320 and the output portion 330 are the same as the corresponding functions of the search apparatus 300 in the system shown in FIG. 3. However, in the system shown in FIG. 8, images that are the same as printout images are held as log images by the log information holding portion 200. Therefore, the search portion 320 compares each of these images and a printout image acquired by the image reading portion 310, and thereby determines degrees of similarity. Additionally, search processing performed by this search apparatus 300 also follows the flowchart shown in FIG. 4.

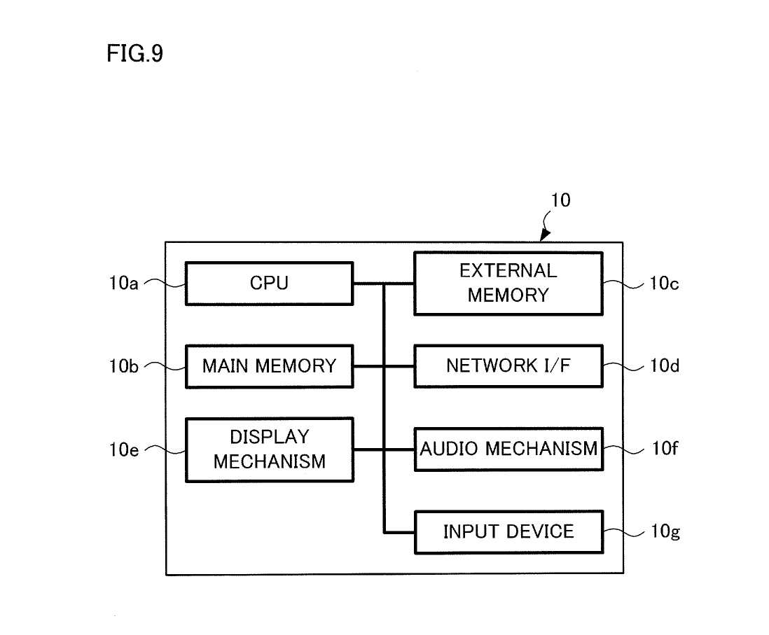

FIG. 9 shows an example of a hardware configuration of a computer that implements the search apparatus 300 in the exemplary embodiment.

A computer 10 shown in FIG. 9 includes: a central processing unit (CPU) 10a as a computing unit; and a main memory 10b and an external memory 10c, as a memory. As the external memory 10c, a magnetic disk device (HDD: hard disk drive) is used in general. Moreover, the computer 10 shown in FIG. 9 also includes: a network interface (I/F) 10d for connecting the computer 10 to an external device through a network; a display mechanism 10e for outputting a display to a display device; and an audio mechanism 10f for outputting a sound. Further, the computer 10 includes an input device 10g such as a keyboard or a mouse. A chip set and a bridge circuit, which are not shown in the figure, exist between the CPU 10a and the other components.

In FIG. 9, each of the components is connected through various kinds of buses such as a system bus and an input-output bus. For example, the CPU 10a and the main memory 10b are connected through a system bus or a memory bus. In addition, the CPU 10a and the other devices such as the external memory 10c, the network I/F 10d, the display mechanism 10e, the audio mechanism 10f and the input device 10g are connected through an input-output bus such as a peripheral components interconnect (PCI), a PCI Express, a serial AT Attachment (ATA), a universal serial bus (USB) or an accelerated graphics port (AGP).

Note that, FIG. 9 is only an example of a hardware configuration of a computer that may implement the search apparatus 300, and thus the hardware configuration is not limited to that shown in the figure. For example, as a sub memory, a drive using a medium such as a flexible disk or an optical disk and a USB memory may be provided in addition to the external memory 10c. The USB memory is connected to the bridge circuit through the USB. The display mechanism 10e and the audio mechanism 10f may be provided as a function of the chip set, instead of the independent configurations.

In the case where the search apparatus 300 in the present exemplary embodiment is implemented by the computer 10 shown in FIG. 9, functions of the search portion 320, the output portion 330 and the image synthesizing portion 340 are implemented by the CPU 10a controlled by a program, and the main memory 10b. The program is stored in a memory such as the external memory 10c. This program is loaded into the main memory 10b, and is executed by the CPU 10a. Thereby, these functions are achieved. In addition, the image reading portion 310 is implemented by an image reading apparatus (scanner) as an external device not shown in the figure, which is connected to the computer 10. In the case where the log information holding portion 200 is mounted on the search apparatus 300, the log information holding portion 200 is implemented by the external memory 10c.

While this exemplary embodiment has been described above, the technical scope of the present invention is not limited to a scope described in the above-mentioned exemplary embodiment. For example, while the specific methods for acquiring a log image and searching image logs have been described, these methods may be used individually or in combination. Specifically, the image logs may be searched by making a complex determination on similarity between a printout image and each of log images. Additionally, while the search apparatus 300 includes the image reading portion 310 as the printout image acquiring unit 301 in each of the configuration shown in FIGS. 3, 5, 7 and 8, another configuration may be employed in which a printout image is acquired by an externally-connected image reading apparatus (a scanner). Other configurations obtained by adding various changes or improvements to the above-mentioned exemplary embodiment are included in the technical scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing system comprising:
a printing unit that prints a document image on a medium;
an image reading unit that performs image reading on the medium;
a holding unit that holds history information on processing performed by the printing unit; and
a search unit that searches the history information held by the holding unit on the basis of an image of a printout which is the medium with the document image printed on the medium by the printing unit,
the search unit determining similarity between the image of the printout and a synthetic image in which the document image is synthesized with an image of the medium read by the image reading unit, and searching for history information on processing performed for the printout on the basis of a result of the determination.

2. The document processing system according to claim 1, wherein
the holding unit holds the synthetic image in which the document image is synthesized with the image of the medium read by the image reading unit, as a part of the history information or in association with the history information, and
the search unit determines similarity between the synthetic image held by the holding unit and the image of the printout.

3. The document processing system according to claim 1, wherein
the holding unit holds the document image and the image of the medium read by the image reading unit, as a part of the history information or in association with the history information, and
the search unit acquires and synthesizes the document image and the image of the medium which are held by the holding unit, and determines similarity between the synthetic image thus synthesized and the image of the printout.

4. The document processing system according to claim 1, wherein
the image reading unit acquires the synthetic image in which the document image is synthesized with the image of the medium, by performing image reading on the medium after the document image is printed on the medium by the printing unit,
the holding unit holds the synthetic image acquired by the image reading unit, as apart of the history information or in association with the history information, and
the search unit determines similarity between the synthetic image held by the holding unit and the image of the printout.

5. A search apparatus comprising:
a printout image acquiring unit that acquires an image of a printout which is a medium with a document image printed on the medium, the image of the printout being obtained by performing image reading on the printout; and
a search unit that determines similarity between the image of the printout acquired by the printout image acquiring unit, and a synthetic image in which the document image is synthesized with a medium image that is an image of the medium, and that searches for information on a document image corresponding to the image of the printout in accumulated information on the document image on the basis of a result of the determination.

6. The search apparatus according to claim 5, wherein
the search unit acquires the synthetic image from a memory, and determines similarity between the synthetic image thus acquired and the image of the printout, the memory holding the synthetic image in association with information on the document image.

7. The search apparatus according to claim 5, further comprising a synthesizing unit that acquires the document image and the medium image from a memory, and that produces a synthetic image by synthesizing the document image and the medium image thus acquired, the memory holding the document image and the medium image in association with information on the document image, wherein
the search unit determines similarity between the image of the printout and the synthetic image produced by the synthesizing unit.

8. The search apparatus according to claim 5, further comprising:
an image producing unit that acquires, from a memory, medium information indicating characteristics as the image of the medium, and that produces the medium image on the basis of the medium information thus acquired, the memory holding the document image and the medium information in association with the information on the document image; and
a synthesizing unit that acquires the document image from the memory, that acquires the medium image from the image producing unit, and that produces a synthetic image by synthesizing the document image and the medium image thus acquired, wherein
the search unit determines similarity between the synthetic image produced by the synthesizing unit and the image of the printout.

9. The search apparatus according to claim 5, wherein
the search unit acquires, from a memory, the synthetic image obtained by performing image reading on the medium after the document image is printed on the medium, and determines similarity between the synthetic image thus acquired and the image of the printout, the memory holding the synthetic image in association with the information on the document image.

10. An information searching method comprising:
acquiring an image of a printout which is a medium with a document image printed on the medium, the image of the printout being obtained by performing image reading on the printout; and
determining similarity between the image of the printout and a synthetic image in which the document image is synthesized with a medium image that is an image of the medium; and
searching for information on a document image corresponding to the image of the printout in accumulated information on the document image on the basis of a determination result of the similarity.

11. A document processing method of a document processing system including: a printing unit that prints a document image on a medium; an image reading unit that performs image reading on the medium; a holding unit that holds history information on processing performed by the printing unit; and a search unit that searches the history information held by the holding unit on the basis of an image of a printout which is the medium with the document image printed on the medium by the printing unit, the document processing method comprising:
determining similarity between the image of the printout and a synthetic image in which the document image is synthesized with an image of the medium; and
searching for history information on processing performed for the printout on the basis of a result of the determination.

12. A computer readable medium storing a program causing a computer to execute a process for information search, the process comprising:
acquiring an image of a printout which is a medium with a document image printed on the medium, the image of the printout being obtained by performing image reading on the printout; and
determining similarity between the image of the printout and a synthetic image in which the document image is synthesized with a medium image that is an image of the medium; and
searching for information on a document image corresponding to the image of the printout in accumulated information on the document image on the basis of a determination result of the similarity.
